(19) United States
(12) Patent Application Publication
(10) Pub. No.: US 2025/0356828 A1
(43) Pub. Date: Nov. 20, 2025

(54) Interchangeable Door Knocker

(71) Applicant: Sushi Diebold Groff, Philadelphia, PA (US)

(72) Inventor: Sushi Diebold Groff, Philadelphia, PA (US)

(21) Appl. No.: 18/665,170

(22) Filed: May 15, 2024

(51) Int. Cl. G10K 1/10

(52) U.S. Cl. CPC G10K 1/10

(57) ABSTRACT

According to an aspect of the present invention, there is provided a door knocker, comprising: a mounting plate; a cleat; a hinge attached to the cleat; and an ornament attached to the hinge configured to knock against the mounting plate and cleat.

### BACKGROUND

Door knockers have been disclosed a number of times in the prior art patent literature.

In U.S. Pat. No. 4,004,547, for example, the disclosed invention relates to a door knocker comprising: (a) an elongated base for mounting on the outer surface of a door said base consisting of a transverse piece having an outer surface and a recessed portion and an upright piece having a back face abutting the outer surface of the door, a front face and a top; and (b) a knocker element having a knocking surface and an outer surface, said knocker element being disposed longitudinally coextensive to the front face of the upright piece and having one end connected to the top half of the upright piece for swinging movement of the knocker element toward and away from the upright piece of the base and within the recessed portion of the transverse piece to strike the front face of the upright piece with the knocking surface, wherein the outer surface of the transverse piece and the outer surface of the knocking element are in the same plane.

U.S. Pat. No. 3,734,054 discloses a door knocker comprising a base plate member adapted to be affixed to a door and a hammer pivotally connected to the plate member, the improvement comprising: said hammer having a generally horizontal shaft member, said plate member having journals rotatably supporting said shaft member for movement about a horizontal axis; spring means operatively connecting the hammer and the plate member and resiliently biasing the hammer to a normal position spaced from the plate member, whereby to operate the knocker one need only push the hammer toward the plate member from said position, said spring means including a leaf spring affixed to one member and bearing against a part of the other member.

Nevertheless, prior art door knockers have a number of limitations including lack of convenience and adaptability.

### SUMMARY OF INVENTION

Therefore, the present invention is a novel interchangeable door knocker which allows for a variety of ornaments to be attached, detached, and replaced according to the season, occasion.

According to an aspect of the present invention, there is provided a door knocker, comprising: a mounting plate; a cleat; a hinge attached to the cleat; and an ornament attached to the hinge configured to knock against the mounting plate and cleat.

### BRIEF DESCRIPTION OF THE DRAWINGS

FIG. 1 illustrates an exploded view of the door knocker according to an embodiment of the present invention.

### DETAILED DESCRIPTION

Embodiments of the present invention will be described in accordance with the appended drawings.

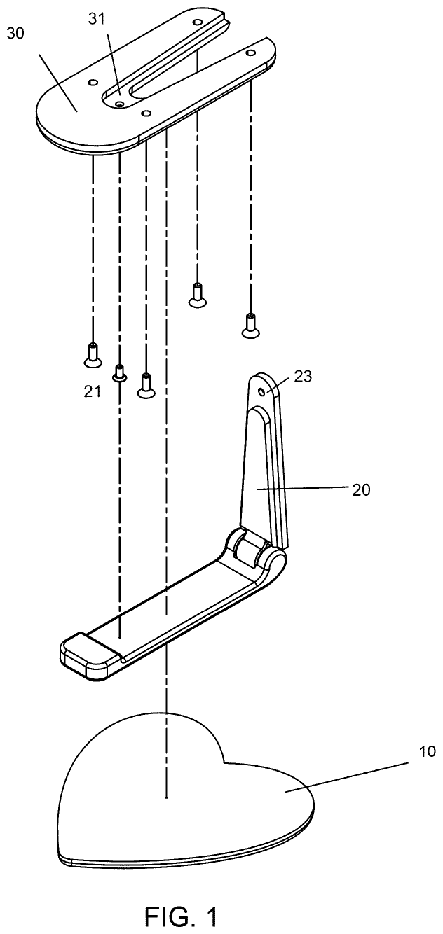

FIG. 1 illustrates an exploded view of the door knocker according to an embodiment of the present invention.

Mounting plate 30 is designed to be attached to a door, by screws through screw holes in mounting plate 30 or by another mechanism such as an adhesive. Mounting plate 30 is shaped for receiving cleat 20 at the top end of the mounting plate.

A cleat 20 has a hinge attached at its top end. That way, a knocking motion can be made by activating the hinge to move towards and away from the door. While in the embodiment the hinge is attached at the top end, in other embodiments different configurations are possible.

An ornament 10 is attached to the hinge configured to knock against the mounting plate and cleat. While shown as a heart, the ornament can be a shape, team logo, religious symbol, or take on many other possible decorative forms.

The ornament can be permanently attached to the cleat or removably attached to the cleat. The door knocker can therefore be interchanged either by interchanging a different cleat with a different ornament attached or by interchanging a different ornament from the same cleat either with a latch or adhesive or other attachment.

Screw 21 is configured to attach the hinge and cleat to the mounting plate by hole 23 in and hole 31 in the mounting plate. Then the cleat is secured tightly in the mounting plate and the ornament 10 can be used to knock on the door by activating the hinge.

The cleat is finger shaped in the embodiment and the mounting plate is configured to receive a finger. In other embodiments the cleat and mounting plate may be in other complementary shapes or fit together in a lock and key formation.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description.

Other embodiments may be utilized and derived from the present invention, such that structural and logical substitutions and changes may be made without departing from the scope of this disclosure.

Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments.

Combinations of the above embodiments, and other embodiments not specifically described herein, will be apparent to those of skill in the art upon reviewing the above description. Therefore, it is intended that the disclosure not be limited to the particular embodiment(s) disclosed.

Once given the above disclosure, many other features, modifications, and improvements will become apparent to the skilled artisan. Such other features, modifications, and improvements are therefore considered to be part of the present invention, the scope of which is to be determined by the following claims.

What is claimed is:

1. A door knocker, comprising:
a mounting plate;
a cleat;
a hinge attached to the cleat; and
an ornament attached to the hinge configured to knock against the mounting plate and cleat.

2. The door knocker of claim 1, further comprising one or more screw holes in the mounting plate.

3. The door knocker of claim 1, wherein the ornament is permanently affixed to the hinge.

4. The door knocker of claim 3, wherein the ornament is permanently affixed to the hinge by welding or molding.

5. The door knocker of claim 1, wherein the ornament is temporarily affixed to the hinge.

6. The door knocker of claim 5, wherein the ornament is temporarily affixed to the hinge by a notch, latch, or adhesive.

7. The door knocker of claim 1, wherein the ornament is a shape.

8. The door knocker of claim 1, wherein the ornament is a team logo.

9. The door knocker of claim 1, wherein the mounting plate is finger-shaped.

10. The door knocker of claim 9, wherein the cleat has a finger-shaped hole to fit the mounting plate.

11. The door knocker of claim 1, further comprising a threaded hole in the cleat.

12. The door knocker of claim 1, further comprising a tamper-proof screw in the mounting plate.
